(19) United States
(12) Patent Application Publication
(10) Pub. No.: US 2026/0289068 A1
(43) Pub. Date: Sep. 24, 2026

(54) ARTIFICIAL INTELLIGENCE (AI)-BASED TECHNIQUES FOR SECONDARY CONTENT OF ELECTRONIC DOCUMENTS

(71) Applicant: Google LLC, Mountain View, CA (US)

(72) Inventors: Aizaz Ahmed, Campbell, CA (US); Bruno Miguel Bras Silva, Jersey City, NJ (US)

(21) Appl. No.: 19/088,791

(22) Filed: Mar. 24, 2025

(51) Int. Cl. G06F 40/106; G06F 40/166

(52) U.S. Cl. CPC G06F 40/106; G06F 40/166

(57) ABSTRACT

Methods and systems for artificial intelligence (AI) AI-based techniques for secondary content of electronic documents. Primary content provided by a user associated with an electronic document is identified. The primary content is included in a first region of the document. The primary content is included as an input to an AI model. One or more outputs of the AI model are obtained. The one or more outputs include secondary content corresponding to at least one of a style, a format, or a context of the primary content. The document is provided for presentation via a client device associated with the user. The primary content is included in the first region of the document and the secondary content is included in at least one of a background of the primary content in the first region or at a second region of the document that is adjacent to the first region.

### TECHNICAL FIELD

Aspects and implementations of the present disclosure relate to methods and systems for AI-based techniques for secondary content of electronic documents.

### BACKGROUND

A collaborative document platform can enable users to create and/or customize content of electronic documents, such as slide presentation documents, word processing documents, and so forth. Primary content of an electronic document can include content that is the focus or a purpose of the electronic document (e.g., substantive content, etc.), while secondary content can include content that enhances the overall design or aesthetic of the electronic document (e.g., background images, design elements, etc.).

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes identifying primary content provided by a user associated with an electronic document. The primary content is included in a first region of the electronic document. The method further includes providing the primary content as an input to an artificial intelligence (AI) model. The method further includes obtaining one or more outputs of the AI model. The one or more outputs include secondary content corresponding to at least one of a style, a format, or a context of the primary content. The method further includes providing the electronic document for presentation via a client device associated with the user. The primary content is included in the first region of the electronic document and the secondary content is included in at least one of a background of the primary content in the first region or at a second region of the electronic document that is adjacent to the first region.

In some implementations, the method further includes providing an indication of a layout of the electronic document as an additional input to the AI model. The secondary content of the one or more outputs of the AI model further corresponds to the indicated layout of the electronic document.

In some implementations, a portion of the secondary content is included in the background of the primary content in the first region. In view of the indicated layout of the electronic document, the portion of the secondary content has a degree of contrast with respect to the primary content that falls below a threshold degree of contrast.

In some implementations, the method further includes identifying data indicating at least one of a preferred style or a preferred format associated with the user. The method further includes providing the identified data as an additional input to the AI model. The secondary content of the one or more outputs of the AI model further corresponds to the at least one of the preferred style or the preferred format indicated by the identified data.

In some implementations, the one or more outputs of the AI model further include an updated version of at least one content item of the primary content.

In some implementations, the primary content includes one or more of a text content item, an image content item, a video content item, a drawing object content item, or an annotation content item. The secondary content includes one or more of a background color content item, a background image content item, or an additional image content item.

In some implementations, the method further includes receiving a user query including a natural language description of one or more target features of the secondary content. The method further includes generating a prompt based on the natural language description of the user query. The method further includes providing the generated prompt as an additional input to the AI model. The secondary content further corresponds to at least one target feature of the one or more target features.

In some implementations, the AI model includes a generative AI model. The secondary content is generated based on the at least one of the style, the format, or the context of the primary content.

In some implementations, the secondary content is retrieved from a datastore including multiple secondary content items for electronic documents associated with a platform. The secondary content includes at least one secondary content item having a degree of correspondence to the at least one of the style, the format, or the context of the primary content that is higher than the degree of correspondence for other secondary content items of the secondary content items.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example platform, an example predictive system, and an example secondary content engine, in accordance with implementations of the present disclosure.

FIG. 3 depicts a flow diagram of an example method for obtaining secondary content corresponding to primary content of an electronic document, in accordance with implementations of the present disclosure.

FIGS. 4A-4B depict examples of obtaining secondary content corresponding to primary content of an electronic document, in accordance with implementations of the present disclosure.

FIG. 5 is a block diagram illustrating an exemplary computer system, in accordance with implementations of the present disclosure.

### DETAILED DESCRIPTION

Aspects of the present disclosure relate to artificial intelligence (AI)-based techniques for secondary content of an electronic document. A platform (e.g., a collaborative document platform) can provide users with access to tools or functionalities that enable the users to collaborate on one or more electronic documents (e.g., word documents, spreadsheet documents, slide presentation documents, etc.) and/or communicate with other users via messaging tools (e.g., electronic mail (e-mail) tools, chat messaging tools, etc.). For example, a user can access tools or resources of a collaborative document platform to create and/or customize content of a slide presentation document. An electronic document can include primary content, which is related to the purpose or focus of the electronic document. In an illustrative example, primary content of a slide presentation document created for use in an academic presentation on a particular topic can include substantive information (e.g., textual content organized into bullet points, paragraphs, or quotations, image content including images pertaining to the topic, etc.). An electronic document can additionally or alternatively include secondary content, which can include background images or other design elements that enhance the design or aesthetic of the electronic document. In accordance with the illustrative example, the slide presentation document can include background images that the user associated with the document has selected as relevant to the topic of the presentation.

Secondary content can be useful to garner and maintain an audience's attention when consuming the primary content of an electronic document. Conventionally, a user provides or otherwise identifies secondary content of an electronic document that relates to the context of the primary content and/or is expected to catch the attention of the audience. It can be difficult and time consuming for a user to identify a secondary content that is relevant to the context, style, or format associated with the primary content of the document and to configure such secondary content in a way that is aesthetically pleasing to an audience and complements the presentation of the primary content. For example, a user can spend a significant amount of time (e.g., hours, days, weeks, etc.) identifying appropriate secondary content that complements primary content of an electronic document and an even larger amount of time designing or otherwise configuring the presentation of the secondary content with the primary content in a way that will be interesting and aesthetically pleasing to the target audience. Identifying and designing the presentation of secondary content of an electronic document can involve accessing tools and resources of the platform that consume a larger amount of computing resources (e.g., processing cycles, memory space, network bandwidth, etc.). Such computing resources are unavailable to other processes of the platform, and therefore an overall efficiency of the system is decreased and an overall latency of the system is increased.

Some platforms provide users with access to AI-based tools that can generate an electronic document based on a user-provided query including target content and/or features of the electronic document. While such tools can provide a user with an AI-generated document that attempts to reflect the content or features requested by the user, conventional platforms and systems do not enable users to leverage such tools to generate only secondary content while allowing for user control over the substance and design of the primary content. Accordingly, a user accessing such tools may need to provide continuous user queries pertaining to the generation of content of an electronic document until an electronic document including the target primary content and secondary content of the user is generated. Generating multiple electronic documents using AI systems and resources consume a significant amount of computing resources, which further decreases the overall efficiency of the system and increases the overall latency of the system.

Implementations of the present disclosure address the above and other deficiencies by providing methods and systems for AI-based techniques for secondary content of an electronic document. In some embodiments, a platform can provide users with tools and functionalities to enable the users to create, update, or otherwise provide content for inclusion in an electronic document (e.g., via a graphical user interface (GUI) of a client device). Content provided by a respective user may include primary content, which pertains to the purpose or focus of the electronic document. In an illustrative example, the electronic document can include a slide presentation document associated with a sales presentation for a product. The primary content may include a textual description of the product, an image depicting the product, a table or chart including data associated with a sale of the product, and so forth. In some instances, the user may create or otherwise provide the primary content according to a particular style or formatting. The primary content can be included in a first region of the electronic document, as described herein.

The platform may identify secondary content that corresponds to the style, format, or context of the primary content based on an output of one or more AI models that are trained to generate or otherwise obtain secondary content based on given primary content. Secondary content can correspond to a style, format, or context of primary content if elements or features of the secondary content relate to the context of the primary content, the secondary content can be included in the regions of the electronic document so to not contrast or distract from the primary content, and/or the secondary content enhances or otherwise complements the primary content (e.g., in accordance with design or aesthetic principles or protocols associated with the electronic document).

In some embodiments, the platform can provide the primary content as an input to the AI model. The platform may additionally or alternatively provide data indicating the layout of the primary content in the electronic document, the format of the primary content, and or the style of the primary content as an input to the AI model. The indication of the layout of the primary content can include masking data that indicates regions of the electronic document include the primary content and/or regions of the document do not include the primary content. The platform can obtain one or more outputs of the AI model, which can include secondary content that is obtained based on the style, format, and/or context of the primary content. In some embodiments, the AI can include a generative AI model that generates the secondary content based on the given input(s). In additional or alternative embodiments, the AI model can identify secondary content that corresponds to the style, format, or context of the primary content. Further details regarding the secondary content that is obtained based on the output(s) of the AI model are described herein.

The platform can provide the electronic document for presentation to a user, which can include the user-provided primary content in the first region. The secondary content can be included in a background of the primary content in the first region and/or in a second region that is adjacent to the first region. As described above, the input(s) to the AI model can include an indication of a region of the electronic document that includes the primary content (e.g., the first region). The secondary content included in the output(s) of the AI model can contain features that are specifically generated or otherwise identified to not contrast and/or to otherwise enhance the presentation of the primary content in the first region. In an illustrative example, a portion of the secondary content that is included in a background of the primary content in the first region may have a color or a design that enables the primary content to be visible. For instance, if the color of a text content item of the primary content is black, the portion of the secondary content that is included in the background of the primary content can be a different color that enables the visibility of the text content item and/or complements the color of the text content item (e.g., in accordance with aesthetic or design principles of or identified by the AI model). As also described above, the secondary content (either included in the first region with the primary content or in the second region adjacent to the first region) may correspond to the context of the primary content. In accordance with the previous illustrative example, the secondary content can include design elements (e.g., a color, an image, etc.) that are reflective or otherwise correspond to the features of the product referenced by the text of the primary content and/or depicted by the image of the primary content. Accordingly, the secondary content can enhance the overall design and/or aesthetic of the primary content without obscuring or impacting the visibility of the primary content (e.g., as provided by the user).

Aspects of the present disclosure provide techniques for AI-based techniques for obtaining secondary content for inclusion in an electronic document, where the secondary content complements or otherwise corresponds to user-provided primary content of the electronic document. As described herein, a platform can provide primary content specified by a user and/or information associated with the primary content (e.g., a layout, a style, a format, etc. associated with the user-provided primary content) as an input to an AI model and obtain one or more outputs of the AI model, which include secondary content that corresponds to the style, format, and/or context of the primary content. The secondary content obtained based on the output(s) of the AI model can include secondary content items that are generated by the AI model and/or secondary content items that are identified (e.g., from a data store or corpus of secondary content items) to complement or otherwise not obscure (e.g., block, contrast with, etc.) the presentation of the primary content of the electronic document. As described herein, embodiments of the present disclosure enable the platform to automatically obtain secondary content for inclusion in an electronic document with the primary content, which prevents the user from spending a significant amount of time, and therefore a significant number of computing resources (e.g., processing cycles, memory space, network bandwidth, etc.) identifying secondary content that complements and/or is relevant to the primary content. Further, embodiments of the present disclosure provide that the AI model generates or otherwise obtains the secondary content, rather than generating both the primary content and the secondary content, which enables the user to control the substance and design of the primary content. The system also consumes fewer computing resources by obtaining the secondary content (e.g., without also generating the primary content), which increases the overall efficiency of the system and decreases an overall latency of the system.

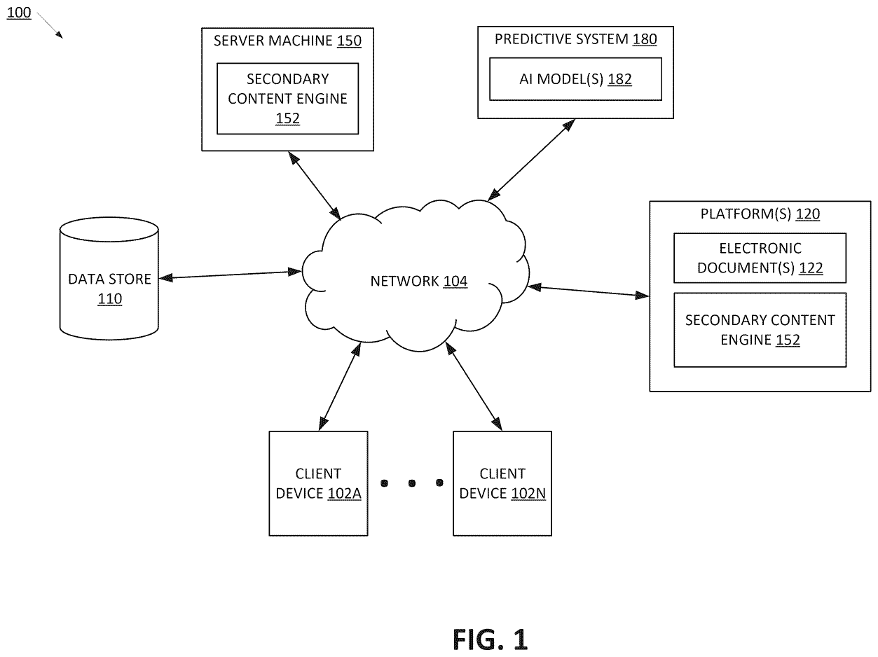

FIG. 1 illustrates an example system architecture 100, in accordance with implementations of the present disclosure. The system architecture 100 (also referred to as “system” herein) includes one or more client devices 102A-N, a data store 110, a platform 120 (e.g., a collaborative document platform, a productivity platform, etc.), one or more server machines (e.g., server machine 150), and/or a predictive system 180, each connected to a network 104. In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data can include (or include data of) one or more electronic documents and/or metadata associated with the one or more electronic documents, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines (e.g., server machine 150) coupled to the platform 120 via network 104.

Client devices 102A-N (collectively and individually referred to as client device(s) 102 herein). can include one or more computing devices such as personal computers (PCs), laptops, mobile phones, smart phones, tablet computers, netbook computers, network-connected televisions, etc. In some implementations, a client device 102 can also be referred to as a “user device.” Client devices 102 can include a content viewer. In some implementations, a content viewer can be an application that provides a user interface (UI) for users to view or upload content, such as images, media items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital media items, digital images, electronic books, etc.). In some implementations, the content viewer can be an electronic document platform application for users to generate, edit, and/or upload content for electronic documents on the platform 120. In other or similar implementations, the content viewer can be an electronic messaging platform application (e.g., an electronic mail (e-mail) application) for users to generate and send messages via platform 120. As such, the content viewers can be provided to the client devices 102A-102N by platform 120.

In some implementations, platform 120 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to a file (e.g., an electronic document, an e-mail message, etc.) and/or provide the file to the user. For example, platform 120 can be an electronic document platform, such as a collaborative document platform or a productivity platform. The electronic document platform may allow a user to create, edit (e.g., collaboratively with other users), access or share with other users an electronic document stored at data store 110. In another example, platform 120 can allow a user to create, edit, or access electronic messages (e.g., e-mails) addressed to other users of the electronic messaging platform or users of client devices outside of the electronic messaging platform. Platform 120 can also include a website (e.g., a webpage) or application back-end software that can be used to provide a user with access to files.

As described above, platform 120 can provide users with access to one or more electronic communication services that enable users to correspond with other users of platform 120 and/or non-users of platform 120. An electronic communication service includes any service that enables the transmission of electronic message(s) between client devices 102 of system 100 or of other client devices of another system. In some embodiments, the electronic communication service can include an electronic mail (e-mail) communication service, a chat message communication service, and so forth. It should be noted that although some embodiments herein are described with respect to e-mail communication and chat messaging communication, such embodiments can be applied to any type of communication between users and/or between client devices 102 of users. For example, electronic message(s) can include e-mail messages, chat messages (e.g., instant messages), comment messages associated with an electronic document associated with the platform 120 and/or users of the platform 120, messages transmitted during a virtual meeting hosted by the platform 120, messages and/or information associated with tasks or calendar events associated with users of the platform 120, and so forth.

In some embodiments, functionalities of platform 120 can be supported by one or more AI models 182 (collectively and individually referred to as AI models 182 or AI model 182 herein) provided by predictive system 180. An AI model 182 can be trained to perform multiple types of tasks pertaining to the functionalities of platform 120 and/or files of platform 120. Such tasks include, but are not limited to, content generation, content summarization, content expansion, data classification, knowledge retrieval, and so forth, as well as performing operations on behalf of a requesting user (e.g., creating a calendar invitation, generating and transmitting an electronic message, etc.). A user of platform 120 can access the AI model(s) 182 of predictive system 180 via one or more tools or resources of platform 120. For example, platform 120 can provide a client device 102 associated with a user with access to a user interface (UI) for an application that enables a user to create and/or edit a collaborative electronic document (e.g., a collaborative word document, a collaborative spreadsheet document, a collaborative slide presentation document, etc.). The UI can include one or more UI elements that enable the user to engage with the AI model(s) 182 of predictive system 180 in accordance with the functionality of the application. For instance, the UI can include a UI element that enables a user to request generated content from the AI model(s) 182. Such request can include or otherwise correspond to a query for AI model(s) 182. Upon detecting a user engagement with the UI element (e.g., via a UI of the client device 102), the platform can provide the query to predictive system 180. Predictive system 180 can provide a prompt associated with the query as an input to the AI model(s) 182 and can obtain an output of the model(s), which can include generated content, in accordance with the example. A prompt refers to a natural language text that requests the AI model(s) 182 to perform a specific tasks. In some embodiments, a prompt can include the query provided by the user and/or can include additional or alternative information associated with the query provided by the user. Platform 120 can update the UI provided to the client device 102 to include the generated content for presentation to the user. It should be noted that embodiments of the present disclosure are not limited to the tasks or functions explicitly described herein (e.g., content generation, content summarization, etc.) and embodiments can be applied to any type of task or function that could be performed by an AI model.

In some embodiments, AI model 182 can be an AI model that has been trained on a corpus of textual data. In some embodiments, the AI model 182 can be a model that is first pre-trained on a corpus of text to create a foundational model, and afterwards fine-tuned on more data pertaining to a particular set of tasks to create a more task-specific, or targeted, model. The foundational model can first be pre-trained using a corpus of text that can include text context in the public domain, licensed content, and/or proprietary content. Such a pre-training can be used by the model to learn broad language elements including general sentence structure, common phrases, vocabulary, natural language structure, and any other elements commonly associated with natural language in a large corpus of text. In some embodiments, this first, foundational model can be trained using self-supervision, or unsupervised training on such datasets.

In some embodiments, the AI model 182 can then be further trained and/or fine-tuned on organizational data, including proprietary organizational data. The AI model 182 can also be further trained and/or fine-tuned on organizational data associated with a file, including proprietary organizational data associated with a file.

In some embodiments, the second portion of training, including fine-tuning, may be unsupervised, supervised, reinforced, or any other type of training. In some embodiments, this second portion of training may include some elements of supervision, including learning techniques incorporating human or machine-generated feedback, undergoing training according to a set of guidelines, or training on a previously labeled set of data, etc. In a non-limiting example associated with reinforcement learning, the outputs of the AI model 182 while training may be ranked by a user, according to a variety of factors, including accuracy, helpfulness, veracity, acceptability, or any other metric useful in the fine-tuning portion of training. In this manner, the AI model 182 can learn to favor these and any other factors relevant to users within an organization, or associated with a virtual meeting, when generating a response. In such a way, a foundational model can be further trained to perform within a virtual meeting, and provide useful information, as well as help to accomplish useful tasks associated with the virtual meeting.

In some embodiments, the AI model 182 may include one or more pre-trained models, or fine-tuned models. In a non-limiting example, in some embodiments, the goal of the “fine-tuning” may be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

In one embodiment, the AI model 182 may be one or more of decision trees, random forests, support vector machines, or other types of machine learning models. In one embodiment, the AI model 145 may be one or more artificial neural networks (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

In some embodiments, the AI model 182 may be one or more recurrent neural networks (RNNs). An RNN is a type of neural network that includes a memory to enable the neural network to capture temporal dependencies. An RNN is able to learn input-output mappings that depend on both a current input and past inputs. The RNN will address past and future measurements and make predictions based on this continuous measurement information. One type of RNN that may be used is a long short term memory (LSTM) neural network.

As indicated above, the AI model 182 may be one or more generative AI models, allowing for the generation of new and original content. The generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks.

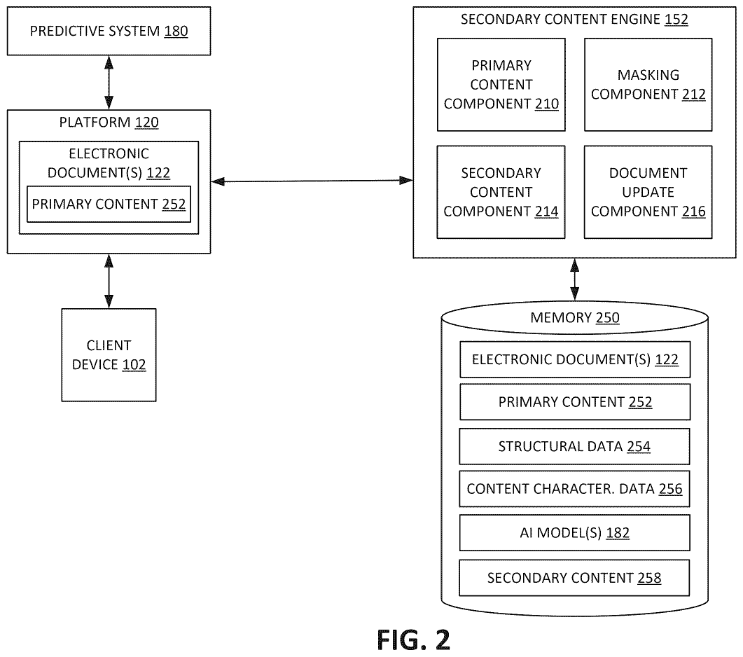

As described above, platform 120 can provide users with access to tools and/or functionalities that enable users to collaborate on electronic documents 122. In some embodiments, such tools and/or functionalities can enable users to create, update, or otherwise provide content for inclusion in an electronic document 122. Content of an electronic document 122 can include primary content or secondary content, in some embodiments. Primary content refers to content that is the focus or a purpose of the electronic document (e.g., substantive content) while secondary content refers to content that enhances the overall design or aesthetic of the electronic document (e.g., background images, design elements, etc.). A user can engage with the tools and/or functionalities via a GUI of a client device 102 to create, update, or otherwise provide content for inclusion in the electronic document 122. In some embodiments, the user can create, update, or otherwise provide primary content for inclusion in the electronic document 122. As illustrated by FIG. 1, platform 120 can include a secondary content engine 152, which can generate or otherwise obtain secondary content for inclusion in the electronic document based on a style, format, and/or context of the user-provided primary content. In some embodiments, AI model(s) 182 can include a generative AI model that generates secondary content corresponding to the primary content. In other or similar embodiments, AI model(s) 182 can include other types of AI models that can identify (e.g., from a data store including secondary items) one or more secondary content items that correspond to the style, format, and/or context of the user-provided primary content. Further details regarding secondary content engine 152 and obtaining secondary content based on the user-provided primary content is described herein with respect to FIGS. 2-4B.

It should be noted that although some embodiments and examples refer to electronic documents such as slide presentation documents, such embodiments can be applied to any type of electronic document. As described herein, electronic documents 122 can include, but are not limited to, word documents, spreadsheet documents, slide presentation documents, webpage documents, messaging documents, and so forth. Further, embodiments and examples can be applied to other systems or contexts. For instance, embodiments and examples of the present disclosure can be applied to any user-provided content, regardless of whether such content is included in an electronic document 122.

It should be noted that although FIG. 1 illustrates secondary content engine 152 as part of platform 120, in additional or alternative embodiments, one or more portions or components of secondary content engine 152 can reside and/or be executed at client device(s) 102. In other or similar embodiments, one or more components of secondary content engine 152 can reside on one or more server machines that are remote from platform 120. In an illustrative example, secondary content engine 152 can reside at server machine 150. It should be noted that in some other implementations, the functions of platform 120, server machine 150, and/or predictive system 180 can be provided by more or a fewer number of machines. For example, in some implementations, components and/or modules of platform 120, server machine 150, and/or predictive system 180 may be integrated into a single machine, while in other implementations components and/or modules of any of platform 120, server machine 150, and/or predictive system 180 may be integrated into multiple machines. In addition, in some implementations, components and/or modules of server machine 150, server machine 160, and/or predictive system 180 may be integrated into platform 120.

In general, functions described in implementations as being performed platform 120, server machine 150, and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 is a block diagram of an example platform 120, an example predictive system 180, and an example secondary content engine 152, in accordance with implementations of the present disclosure. As described above, platform 120 can provide users with access to tools or functionalities that enable users to create, update, or otherwise provide content for inclusion in an electronic document. In some embodiments, a user of client device 102 can access such tools or functionalities to provide primary content 252 for inclusion in an electronic document. Secondary content engine 152 can obtain secondary content that complements or otherwise corresponds to the user-provided primary content 252. As illustrated by FIG. 2, secondary content engine 152 can include a primary content component 210, a masking component 212, a secondary content component 214, and/or a document update component 216. Details regarding the components of secondary content engine 152 are provided herein with respect to FIGS. 2-4B. Platform 120, predictive system 180, and/or secondary content engine 152 can be connected to a memory 250 (e.g., via network 104, via a bus, etc.). Memory 250 can include one or more portions of data store 110, in some embodiments. In other or similar embodiments, memory 250 can include or correspond to any memory of any component of system 100 and/or otherwise accessible to a component of system 100.

As described herein, secondary content engine 152 may obtain secondary content 258 based on one or more outputs of one or more AI model(s) 182. An AI model 182 can be trained to obtain secondary content 258 based on given primary content 252 and/or given information or data associated with primary content 252. In some embodiments, AI model 182 can be a general-purpose AI model that is trained to perform multiple tasks associated with tools or functionalities of platform 120. In other or similar embodiments, AI model 182 can be a specific-purpose AI model that is trained to perform a specific task (e.g., obtaining secondary content 258).

AI model 182 can be or otherwise include a generative AI model, which is trained to generate data or content (e.g., secondary content 258) based on a given input, in some embodiments. The generative AI model may be trained (e.g., by predictive system 180) using a training data set that represents the type of content the model is intended to generate. The training data set can include, for example, text content (e.g., obtained from books, articles, websites, codebases, etc.), image content, audio content, and so forth. The AI model 182 may be trained according to techniques that involve the model learning patterns, relationships, and/or structure in the training data set through an iterative process. Such techniques can include, but are not limited to, data encoding techniques, forward propagation techniques, loss calculation techniques, backpropagation techniques, optimization techniques, and so forth.

In other or similar embodiments, AI model 182 can be trained to identify a secondary content item (e.g., from a data store or a corpus of secondary content items) that corresponds to primary content 252 of an electronic document 122. In some embodiments, AI model 128 can be trained (e.g., by predictive system 180) using a training data set that includes an indication of first content of an electronic document 122, an indication of second content of the electronic document 122, and an indication of a degree of correspondence between the first content and the second content in view of a context, style, or format of the first content. In some embodiments, the first content, the second content, and/or the degree of correspondence can be provided by a developer, an operator, or another user of platform 120. In other or similar embodiments, the first content, the second content, and/or the degree of correspondence can be identified or otherwise determined according to other techniques associated with training an AI model (e.g., synthetic data generation techniques, etc.).

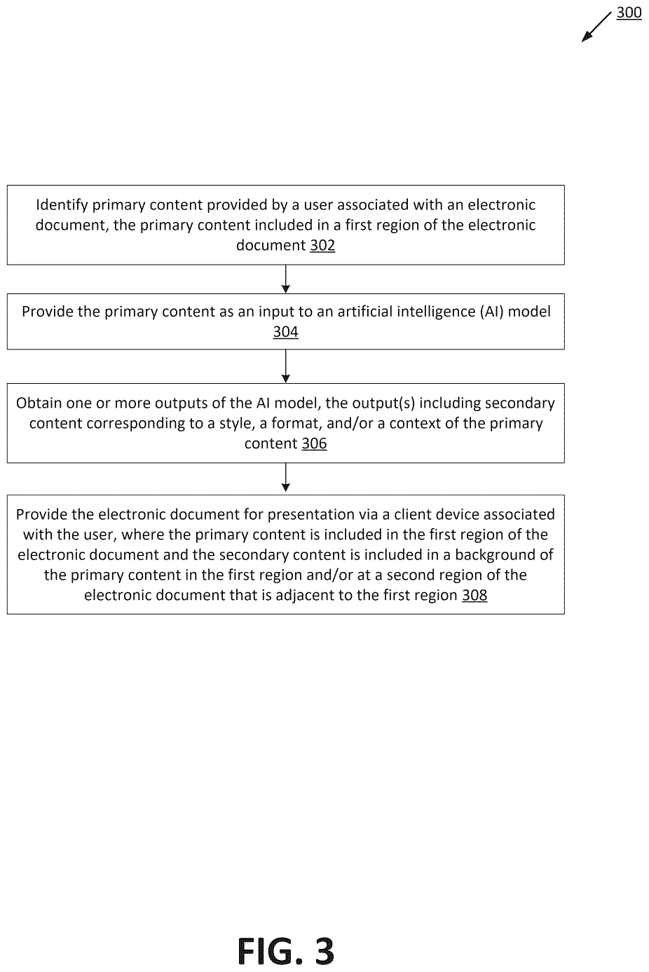

FIG. 3 depicts a flow diagram of an example method 300 for obtaining secondary content corresponding to primary content of an electronic document, in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by secondary content engine 152.

At block 302, processing logic identifies primary content provided by a user associated with an electronic document. The primary content can be included in a first region of the electronic document. As described above, a user can provide create, update, or otherwise provide primary content for inclusion in an electronic document 122 using tools or functionalities of platform 120 (e.g., via client device 102). For example, platform 120 can provide the user with access to such tools or functionalities by providing client device 102 with a GUI including one or more GUI elements that enable a user to provide or indicate content items for inclusion in the electronic document. Such content items can include, but are not limited to, text content items (e.g., characters or text strings), image content items, video content items, drawing object content items (e.g., shapes, lines, etc.), annotation content items (e.g., a highlight object, an underline object, an arrow object, etc. that emphasizes or otherwise annotates another content item), and so forth. Upon detection that the user has provided such content items via the GUI of client device 102, platform 120 store such content items at memory 250 as primary content 252. As described herein, the GUI elements enable the user to provide the content items for inclusion in the electronic document 122 and specify or otherwise define a style or format associated with the provided content items. A style or format of a content item refers to a structure, presentation, or overall design of the content item and can include, but is not limited to, visual aspects of the content item(s) (e.g., a font, a size, a spacing, etc. of the content item(s)), a color or color scheme associated with the content item(s), a tone or voice associated with the content item (e.g., a formal tone, an informal tone, a persuasive tone, an instructional tone, etc.), an organization of the content item(s) (e.g., whether the content(s) items are included as a list or a paragraph, an ordering of the content item(s)), and so forth. As will be seen herein, secondary content engine 152 can obtain secondary content 258 that complements or otherwise corresponds to the context (e.g., semantic meaning or purpose), style, or format of the primary content 252.

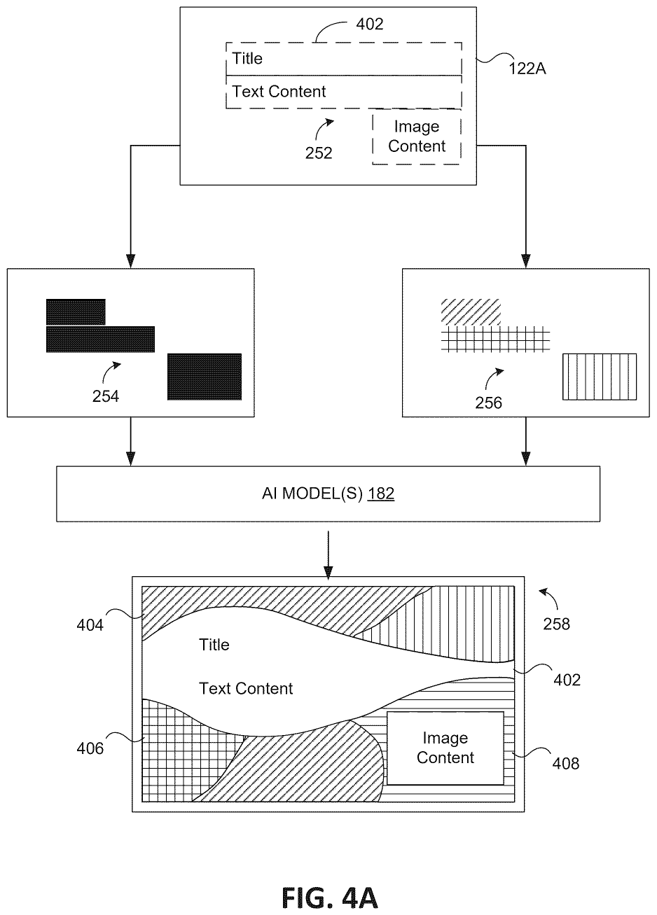

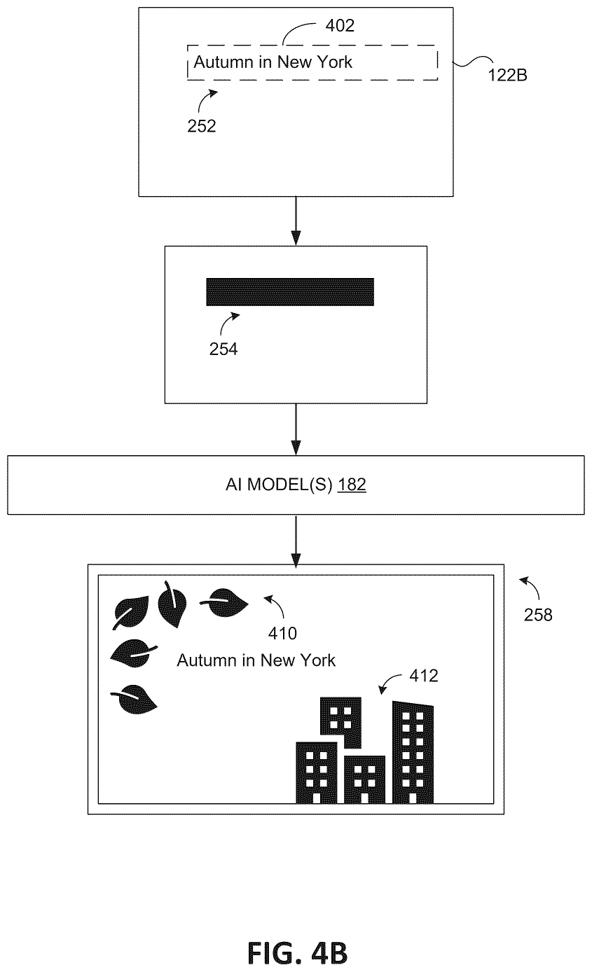

FIGS. 4A-B illustrate example electronic documents 122, in accordance with embodiments of the present disclosure. As illustrated by FIG. 4A, an electronic document 122A can include or otherwise correspond to a slide presentation document and/or a slide of a slide presentation document. The user can provide primary content 252 for inclusion in the electronic document 122A, which can include a title, text content, image content, and so forth. The primary content 252 can be included in a first region 402 of electronic 122A. The electronic document 122A can include one or more second regions (not labeled), which may include any regions of electronic document 122A that do not include user-provided primary content 252.

Referring back to FIG. 3, at block 304, processing logic provides the primary content as an input to an AI model. The AI model can include or otherwise correspond to AI model 182, as described above. In some embodiments, primary content component 210 of secondary content engine 152 can extract primary content 252 from electronic document 122 and provide the extracted primary content 252 as an input to AI model 182. Primary content component 210 may extract primary content 252 by parsing the electronic document 122 to identify elements of the electronic document 122 (e.g., headings, paragraphs, tables, lists, images, videos, metadata, etc.) and determining the identified elements that correspond to content provided by the user (e.g., as opposed to default elements or other types of elements of electronic document 122 that are associated with platform 120). In some embodiments, primary content component 210 can generate one or more embeddings associated with the identified primary content 252 and provide the generated embedding(s) as an input to the AI model 182. An embedding refers to a numerical representation of data (e.g., text, images, etc.) that captures the semantic meaning, relationships, context, etc. of the data in a structured format. Primary content component 210 can generate the embedding(s) by providing the primary content 252 as an input to an embedding engine (not shown) and obtaining one or more outputs of the embedding engine, which can include the embedding(s) representing primary content 252. The embedding(s) can include text embeddings, image embeddings, video embeddings, and so forth. In other or similar embodiments, primary content component 210 can provide the electronic document 122 including the primary content 252 (e.g., as specified by the user) as an input to the AI model 182 (e.g., with or without extracting primary content 252, as described above).

In other or similar embodiments, primary content component 210 can obtain structural data 254 and/or content characteristic data 256 associated with primary content 252 and provide the obtained structural data 254 and/or content characteristic data 256 as an additional input to the AI model 182. In some embodiments, structural data 254 can include an indication of a layout of electronic document 122A, which can define the first region 402 of electronic document 122A as including the primary content 252 and/or the one or more second regions of electronic document 122 as not including the primary content 252. As illustrated by FIG. 4A, the structural data 254 obtained for primary content 252 can indicate the layout of electronic document 122A, which defines the first region 402 as including primary content 252.

In some embodiments, the indicated layout of an electronic document 122A can include or otherwise correspond to masking data associated with each region of electronic document 122A that includes primary content 225. Masking data can include data, metadata, or other such information that can indicate to AI model 182 that primary content 252 is included in regions of electronic document 122A associated with the masking data, and the secondary content 258 included in such regions is to not obscure, distort, or otherwise conflict with the primary content 252. Thus, the masking data can improve the focus of the AI model 182 when generating secondary content items for electronic document 122A, as the masking data can signal to the AI model 182 regions of electronic document 122A that can include rich, interesting and engaging secondary content and/or regions that are to include only complementary, non-conflicting secondary content. Masking component 212 can generate or otherwise obtain masking data for primary content 252 of electronic document 122A by generating or otherwise obtaining a masking bounding box and associating the masking bounding box with the first region 402 of electronic document 122A. The masking bounding box can be associated with the entire first region 402 that includes the primary content 252, a portion of the first region 402, and/or a portion of another region (e.g., in addition to or in place of a portion of the first region 402). In some embodiments, masking component 212 can provide the electronic document 122A (e.g., including primary content 252) as an input to a masking engine (not shown) that identifies regions of an electronic document 122 that includes primary content 252 and generates corresponding masking bounding boxes associated with the identified regions. The masking engine may implement AI-based techniques or non AI-based techniques to generate the masking bounding boxes, in some embodiments. Upon providing the electronic document 112A as an input to the masking engine, masking component 212 can obtain one or more outputs of the masking engine, which can include the generated masking bounding boxes and an indication of an associated region of electronic document 122A.

In some embodiments, primary content component 210 can additionally or alternatively obtain content characterization data 256 associated with primary content 252 and include the content characterization data 256 as an additional input to AI model 182. Content characterization data 256 can indicate or otherwise reflect a style or a format associated with primary content 252. In some embodiments, primary content component 210 can obtain content characterization data 256 based on data or metadata associated with primary content 252. For example, Based on parsing of electronic document 122A, primary content component 210 can detect a title content item of primary content 252 and can determine a style or formatting associated with the title content item (e.g., as provided by the user). Content characterization data 256 can include an indication of a type of the title content item and the determined style or formatting. Primary content component 210 can similarly determine such style and/or formatting for the text content object and/or the image content object of primary content 252 of electronic document 122A and include such information with content characterization data 256, as described above.

In additional or alternative embodiments, primary content component 210 can obtain content characterization data 256 for primary content 252 by providing primary content 252 (or electronic document 122A including primary content 252) as an input to a content characterization model (not shown). The content characterization model may be trained to determine or otherwise predict characteristics of given content, such as a sentiment or tone of the content, a design aesthetic of the content, and so forth. In some embodiments, the content characterization model may be an AI model 182 of predictive system 180 or may be associated with another system connected to or otherwise accessible to platform 120 and/or system 100. Primary content component 210 can provide primary content 252 (or the electronic document 122A including primary content 252) as an input to the content characterization model and can obtain one or more outputs of the content characterization model, which may include content characterization data 256.

As illustrated by FIG. 4A, primary content component 210 can determine the style or formatting of each content item (e.g., the title content item, the text content item, the image content item, etc.) of primary content 252. Each content item may have or be associated with a distinct content characteristic, as illustrated by FIG. 4A. The determined style or formatting associated with each content item of primary content 252 can be included in content characterization data 256 of memory 250.

As described above, primary content component 210 can provide structural data 254 and/or content characterization data 256 as an additional input to AI model 182. In other or similar embodiments, primary content component 210 can provide primary content 252 (or electronic document 122) as an input to AI model 182 and AI model 182 can predict or otherwise determine the structure, format, style, and/or context of primary content 252 in generating and/or identifying corresponding secondary content 258, as described herein.

At block 306, processing logic obtains one or more outputs of the AI model. The one or more outputs can include secondary content that corresponds to a style, a format, and/or a context of the primary content. The secondary content 258 can include one or more secondary content items that are each associated with a distinct region of the electronic document 122 including primary content 252. As described herein, AI model 182 can include a generative AI model, in some embodiments. In such embodiments, the one or more outputs can include one or more secondary content items generated to complement or otherwise correspond to primary content 252, based on the given structural data 254 and/or content characterization data 256 associated with primary content 252. A secondary content item can complement or otherwise correspond to primary content 252 if the secondary content item shares a common theme, concept, or design element with the primary content 252 and/or enhances the presentation of the electronic document 122 (e.g., by improving the design or aesthetic of the electronic document 122) and not conflicting or distorting the primary content 252 of the electronic document 122. In accordance with previous illustrative examples, the primary content 252 can reference a product that is the subject of a sales presentation and the secondary content 258 can include one or more images or videos (e.g., AI-generated images or videos) that depict the product and/or other secondary content items that reflect a design or aesthetic of the product (e.g., common colors, common style, etc.). Secondary content component 214 can extract the generated secondary content 258 from the output(s) of AI model 182, in some embodiments.

In other or similar embodiments, the one or more outputs of AI model 182 can include an indication of one or more secondary content items (e.g., of a data store or corpus including multiple secondary content items) and, for each of the one or more secondary content items, a degree of correspondence between a respective secondary content item and the style, format, and/or context of the primary content 252. In some embodiments, secondary content component 214 can obtain an indicated secondary content item upon a determination that the degree of correspondence between the secondary content item and the style, format, and/or context of the primary content 252 satisfies one or more criteria (e.g., exceeds a threshold degree of correspondence, is larger than the degree of correspondence associated with other secondary content items). In some embodiments, the indication of the one or more secondary content items can include an address or other such identifier for a region of the data store or corpus that includes the secondary content item. Secondary content component 214 can retrieve the secondary content item from the data store or corpus based on the address or identifier, in some embodiments. In other or similar embodiments, the indication of the one or more secondary content items can include the secondary content item(s) themselves. Secondary content component 214 can extract the secondary content item having a degree of correspondence that satisfies the one or more criteria from the output(s) of AI model 182. In some embodiments, upon obtaining the secondary content item that having the degree of correspondence that satisfies the one or more criteria, secondary content component 214 can store the obtained secondary content item at memory 250 as secondary content 258.

At block 308, processing logic provides the electronic document for presentation via a client device associated with the user. The primary content can be included in a first region of the electronic document. The secondary content can be included in a background of the primary content in the first region and/or at a second region of the electronic document that is adjacent to the first region. In some embodiments, document update component 216 can update electronic document 122 to include secondary content 258 with primary content 252. Document update component 216 can determine a region (e.g., the first region, the second region, etc.) for inclusion of the secondary content 258 based on information of the one or more outputs of the AI model 182. In some embodiments, the output(s) of AI model 182 can indicate a type of the secondary content 258 and/or a region of electronic document 122 for inclusion of the secondary content 258 (e.g., in view of the layout of the primary content 252 of electronic document 122). For example, the output(s) of AI model 182 can indicate that the secondary content 258 has a background image type, which can indicate to document update component 216 that the secondary content 258 is to be presented behind primary content 252 in electronic document 122. In another example, the output(s) of AI model 182 can indicate that the secondary content 258 has a design element type, and can also indicate a particular region (e.g., the first region, the second region, etc.) that is to include such secondary content 258. In other or similar embodiments, the output(s) of AI model 182 may not indicate the type or region of electronic document 122 for inclusion of the secondary content 258. In such embodiments, document update component 216 may identify a particular region for inclusion of the secondary content 258 by identifying a region of electronic document 122 that does not include primary content 252.

In accordance with the example illustrated by FIG. 4A, the secondary content 258 can include a background image, where at least a portion of the background image is to be included in the first region 402 of electronic document 122A and at least one or more other portions of the background image is to be included in a second region (e.g., region 404, region 406, region 408, etc.) of electronic document 122A. The portion of the background image that is to be included in the first region 402 may be specifically generated or identified to enhance the presentation of primary content 252 in the first region. For example, as illustrated by FIG. 4A, the portion of the secondary content 258 that is included in the first region 402 of electronic document 122A emphasizes the title content item and the text context item of primary content 252. The portion of the background image that is to be included in the second region (e.g., region 404, region 406, region 408, etc.) may be generated or identified to correspond to the style, format and/or context of primary content 252. For example, as illustrated by FIG. 4A, the style and/or format of region 404 corresponds to (e.g., matches or approximately matches) the style or format of the title content item (e.g., as indicated by content characteristic data 256) and the style and/or format of region 406 corresponds to the style or format of the text content item. As also illustrated by FIG. 4A, a portion of secondary content 258 is included in region 408, which also includes an image content item of primary content 252. As described herein, such portion of secondary content 258 may be generated or otherwise identified to enhance the presentation of the image content item, rather than contrast or distort the image content item.

FIG. 4B illustrates another example electronic document 122B including primary content 252, in accordance with embodiments described herein. As illustrated by FIG. 4B, electronic document 122B can include a title content item or a text content item (e.g., “Autumn in New York”) as primary content 252 in a first region 402. Secondary content engine 152 may obtain structural data 254 (e.g., masking data) associated with the primary content 252 of electronic document 122B, as described above, and may provide the primary content 252 and/or the structural data 254 as an input to AI model 182. Secondary content engine 152 may obtain one or more outputs of AI model 182, which can include or otherwise indicate secondary content 258 that is generated or otherwise obtained based on the style, format, and/or context of primary content 252. In accordance with the example of FIG. 4B, as the primary content 252 references “Autumn in New York,” the secondary content 258 can include a first secondary content item 410 that includes an image or graphic of leaves and/or a secondary content item 412 that includes an image or graphic of a city skyline. Secondary content engine 152 can determine regions of electronic document 122B for inclusion of the secondary content 258 (e.g., based on outputs of the AI model 182, based on structural data 254 associated with primary content 252, etc.) and can update electronic document 122B to include the secondary content 258 in the determined regions for presentation with the primary content 252, in accordance with embodiments described herein.

In some embodiments, the AI model 182 can include one or more additional outputs that include an indication of a modification to be made to a style, format, or context of primary content 252 that will enhance or otherwise improve the presentation of the primary content 252 in electronic document 122 (e.g., in accordance with design or aesthetic guidelines associated with electronic document 122 and/or platform 120). In some embodiments, document update component 216 can update primary content 252 based on the indicated modification and include the modified primary content 252 for presentation in the electronic document 122, as described herein. In some embodiments, document update component 216 may provide a notification to the user of client device 102 of the modification and may update the primary content 252 responsive to a detection that the user has agreed or otherwise authorized the update (e.g., based on an interaction with a GUI element of the GUI).

Embodiments of the present disclosure can also be applied to secondary content 258 that is provided by a user (e.g., with primary content 252). For example, with primary content 252, a user can provide one or more design elements of background images for inclusion in an electronic document 122. Secondary content engine 152 can include the user-provided secondary content 258 with the primary content 252 and/or other information (e.g., structural data 254, content characterization data 256, etc.) as an input to the AI model 182. In some embodiments, the one or more outputs of AI model 182 can include an indication of a modification to the user-provided secondary content 258 that will enhance or otherwise improve the presentation of the primary content 252 (e.g., in accordance with design or aesthetic guidelines associated with electronic document 122 and/or platform 120). Document update component 216 may update the user provided secondary content 258 in accordance with the modification indicated by the output(s) of the AI model 182, as described herein (e.g., in response to detecting a user authorization of the modification).

Secondary content engine 152 can provide additional or alternative data as an input to AI model 182 to obtain secondary content 258, as described herein. For example, secondary content engine 152 may identify content elements and/or content guidelines associated with a user or an organization of the user (e.g., a company, a university, etc.) and provide such content elements and/or content guidelines as an additional or alternative input to the AI model 182. The secondary content 258 of the output(s) of the AI model 182 can be generated or otherwise identified based on the provided content elements and/or content guidelines, as described herein. In other or similar embodiments, the additional or alternative data can include an indication of a preferred style or a preferred format associated with the user and/or a style or format of other documents 122 associated with the user. In yet other or similar embodiments, the electronic document 122 can be included in a set of electronic documents 122 associated with a common file. For example, the electronic document 122 can be a slide of a set of slides associated with a common slide presentation file. In some embodiments, the additional or alternative data provided as input to AI model 182 to obtain secondary content 258 can include primary content 252 and/or secondary content 258 of other electronic documents 122 of the set of electronic documents. Accordingly, the secondary content 258 generated or otherwise obtained for inclusion in the electronic document 122 can correspond to the secondary content 258 of other electronic documents of the set of electronic documents.

In some embodiments, primary content component 210 can provide the primary content 252, the structural data 254 and/or the content characterization data 256 as an input to AI model 182 upon receiving the primary content 252 from client device 102. In other or similar embodiments, primary content component 210 can provide such content and data as input to AI model 182 responsive to a request from client device 102 for secondary content 258. A user of client device 102 can provide the request for secondary content 258 by engaging with one or more GUI elements of the GUI at client device 102 associated with obtaining secondary content 258. For example, a user of client device 102 can provide the request for secondary content 258 by engaging with a button GUI element that is associated with initiating the generation or identification of secondary content 258 for inclusion in electronic document 122. In another example, a user of client device 102 can provide the request for secondary content 258 by providing a natural language query (e.g., via a text box GUI element, via one or more voice commands GUI elements, etc.) via the GUI of client device 102. Client device 102 can provide the natural language query to platform 120 and, upon receiving the natural language query, secondary content engine 152 can generate a prompt based on the natural language query. The generated prompt may include information associated with the secondary content 258, as indicated by the natural language query and/or information associated with the application (e.g., a collaborative document application) that enables the user to access the electronic document. Secondary content engine 152 can provide the generated prompt with the primary content 252, the structural data 254, the content characterization data 256, and/or other or additional information as an input to AI model 182, as described herein. The secondary content 258 can be generated or otherwise identified based on the information of the generated prompt.

In some embodiments, platform 120 can include a collaborative document platform that enables multiple users to collaborate on or otherwise access an electronic document 122. In some embodiments, a first user of a first client device 102A can provide a request for (or otherwise initiate obtaining of) secondary content 258 for an electronic document 122, as described above. Secondary content engine 152 can obtain the secondary content 258 and update electronic document 122 to include the secondary content 258 with primary content 252, as described above, and provide the updated electronic document 122 for presentation via a GUI of first client device 102A, as described herein. In additional or alternative embodiments, secondary content engine 152 (or another component of system 100) can provide the updated electronic document 122 (including primary content 252 and secondary content 258) for presentation via GUIs of other client devices (e.g., one or more of client devices 102B-102N) of users associated with electronic document 122. In some embodiments, secondary content engine 152 can provide the updated electronic document 122 for presentation via GUIs of the other client device(s) immediately (or soon after) electronic document 122 is updated and/or provided for presentation to the first user of the first client device 102A. In some embodiments, secondary content engine 152 may provide the updated electronic document 122 for presentation via GUIs of the other client device(s) in response to a request from the first user of the first client device 102A.

In some embodiments, a user accessing an updated electronic document 122 (e.g., including primary content 252 and secondary content 258) can edit or otherwise modify elements or features of secondary content 258 using one or more tools or features of the GUI provided by platform 120. For example, the user can edit or otherwise modify a color or style of the elements or features, a placement of the elements or features relative to primary content 252, and/or can request updated or modified elements or features (e.g., via a GUI element associated with AI model 182). In some embodiments, a first user that requested or otherwise initiated obtaining of secondary content 258 may access tools or features to edit or modify features or elements of secondary content 252, while other users accessing the updated electronic document may be unable to edit or modify features or elements of secondary content 252 (e.g., in accordance with security or privacy protocols or settings associated with electronic document 122 and/or platform 120). For example, other users having a particular role (e.g., that is different from the role of the first user) may be unable to edit or modify the features or elements of secondary content 252, while users having the same (or a similar role) as the first user may be able to edit or modify the features or elements of secondary content 252.

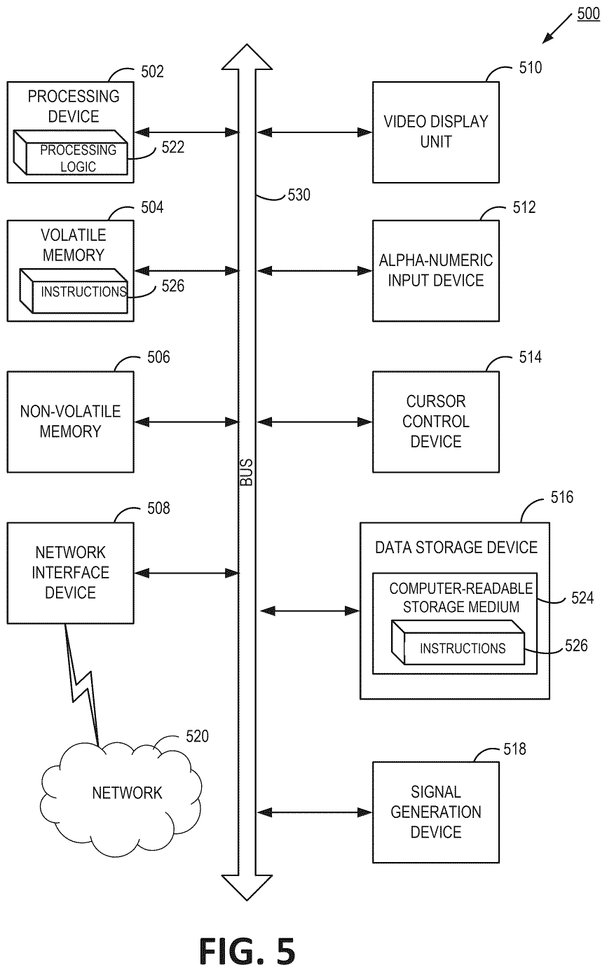

FIG. 5 is a block diagram illustrating an exemplary computer system 500, in accordance with implementations of the present disclosure. The computer system 500 can correspond to platform 120, client devices 52A-N, server machine 150, and/or predictive system 180 described herein and with respect to FIGS. 1-4B. Computer system 500 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 518, which communicate with each other via a bus 540.

Processor (processing device) 502 represents one or more general-purpose processing devices such as a microprocessor, central processing unit, or the like. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 505 for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 520 (e.g., a speaker).

The data storage device 518 can include a non-transitory machine-readable storage medium 524 (also computer-readable storage medium) on which is stored one or more sets of instructions 505 embodying any one or more of the methodologies or functions described herein. The instructions can also reside, completely or at least partially, within the main memory 504 and/or within the processor 502 during execution thereof by the computer system 500, the main memory 504 and the processor 502 also constituting machine-readable storage media. The instructions can further be transmitted or received over a network 530 via the network interface device 508.

In one implementation, the instructions 505 include instructions for providing fine-grained version histories of electronic documents at a platform. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
identifying primary content provided by a user associated with an electronic document, wherein the primary content is included in a first region of the electronic document;
providing the primary content as an input to an artificial intelligence (AI) model;
obtaining one or more outputs of the AI model, wherein the one or more outputs comprise secondary content corresponding to at least one of a style, a format, or a context of the primary content; and
providing the electronic document for presentation via a client device associated with the user, wherein the primary content is included in the first region of the electronic document and the secondary content is included in at least one of a background of the primary content in the first region or at a second region of the electronic document that is adjacent to the first region.

2. The method of claim 1, further comprising:
providing an indication of a layout of the electronic document as an additional input to the AI model, wherein the secondary content of the one or more outputs of the AI model further corresponds to the indicated layout of the electronic document.

3. The method of claim 2, wherein a portion of the secondary content is included in the background of the primary content in the first region, and wherein, in view of the indicated layout of the electronic document, the portion of the secondary content has a degree of contrast with respect to the primary content that falls below a threshold degree of contrast.

4. The method of claim 1, further comprising:
identifying data indicating at least one of a preferred style or a preferred format associated with the user; and
providing the identified data as an additional input to the AI model, wherein the secondary content of the one or more outputs of the AI model further corresponds to the at least one of the preferred style or the preferred format indicated by the identified data.

5. The method of claim 1, wherein the one or more outputs of the AI model further comprise an updated version of at least one content item of the primary content.

6. The method of claim 1, wherein the primary content comprises one or more of a text content item, an image content item, a video content item, a drawing object content item, or an annotation content item, and wherein the secondary content comprises one or more of a background color content item, a background image content item, or an additional image content item.

7. The method of claim 1, further comprising:
receiving a user query comprising a natural language description of one or more target features of the secondary content;
generating a prompt based on the natural language description of the user query; and
providing the generated prompt as an additional input to the AI model, wherein the secondary content further corresponds to at least one target feature of the one or more target features.

8. The method of claim 1, wherein the AI model comprises a generative AI model and wherein the secondary content is generated based on the at least one of the style, the format, or the context of the primary content.

9. The method of claim 1, wherein the secondary content is retrieved from a datastore comprising a plurality of secondary content items for electronic documents associated with a platform, the secondary content comprising at least one secondary content item having a degree of correspondence to the at least one of the style, the format, or the context of the primary content that is higher than the degree of correspondence for other secondary content items of the plurality of secondary content items.

10. A system comprising:
a memory; and
a set of one or more processing devices coupled to the memory, wherein the set of one or more processing devices is to perform operations comprising:
identifying primary content provided by a user associated with an electronic document, wherein the primary content is included in a first region of the electronic document;
providing the primary content as an input to an artificial intelligence (AI) model;
obtaining one or more outputs of the AI model, wherein the one or more outputs comprise secondary content corresponding to at least one of a style, a format, or a context of the primary content; and
providing the electronic document for presentation via a client device associated with the user, wherein the primary content is included in the first region of the electronic document and the secondary content is included in at least one of a background of the primary content in the first region or at a second region of the electronic document that is adjacent to the first region.

11. The system of claim 10, wherein the operations further comprise:
providing an indication of a layout of the electronic document as an additional input to the AI model, wherein the secondary content of the one or more outputs of the AI model further corresponds to the indicated layout of the electronic document.

12. The system of claim 11, wherein a portion of the secondary content is included in the background of the primary content in the first region, and wherein, in view of the indicated layout of the electronic document, the portion of the secondary content has a degree of contrast with respect to the primary content that falls below a threshold degree of contrast.

13. The system of claim 10, wherein the operations further comprise:
identifying data indicating at least one of a preferred style or a preferred format associated with the user; and
providing the identified data as an additional input to the AI model, wherein the secondary content of the one or more outputs of the AI model further corresponds to the at least one of the preferred style or the preferred format indicated by the identified data.

14. The system of claim 10, wherein the one or more outputs of the AI model further comprise an updated version of at least one content item of the primary content.

15. The system of claim 10, wherein the primary content comprises one or more of a text content item, an image content item, a video content item, a drawing object content item, or an annotation content item, and wherein the secondary content comprises one or more of a background color content item, a background image content item, or an additional image content item.

16. The system of claim 10, wherein the operations further comprise:
receiving a user query comprising a natural language description of one or more target features of the secondary content;
generating a prompt based on the natural language description of the user query; and
providing the generated prompt as an additional input to the AI model, wherein the secondary content further corresponds to at least one target feature of the one or more target features.

17. The system of claim 10, wherein AI model comprises a generated AI model and wherein the secondary content is generated based on the at least one of the style, the format, or the context of the primary content.

18. A non-transitory computer readable storage medium comprising instructions that, when executed by a processing device, cause the processing device to perform operations comprising:
identifying primary content provided by a user associated with an electronic document, wherein the primary content is included in a first region of the electronic document;
providing the primary content as an input to an artificial intelligence (AI) model;
obtaining one or more outputs of the AI model, wherein the one or more outputs comprise secondary content corresponding to at least one of a style, a format, or a context of the primary content; and
providing the electronic document for presentation via a client device associated with the user, wherein the primary content is included in the first region of the electronic document and the secondary content is included in at least one of a background of the primary content in the first region or at a second region of the electronic document that is adjacent to the first region.

19. The non-transitory computer readable storage medium of claim 18, wherein the operations further comprise:
providing an indication of a layout of the electronic document as an additional input to the AI model, wherein the secondary content of the one or more outputs of the AI model further corresponds to the indicated layout of the electronic document.

20. The non-transitory computer readable storage medium of claim 19, wherein a portion of the secondary content is included in the background of the primary content in the first region, and wherein, in view of the indicated layout of the electronic document, the portion of the secondary content has a degree of contrast with respect to the primary content that falls below a threshold degree of contrast.
